(19) United States
(12) Patent Application Publication
(10) Pub. No.: US 2021/0029291 A1
(43) Pub. Date: Jan. 28, 2021

(54) APPARATUS, METHOD, AND STORAGE MEDIUM

(71) Applicant: CANON KABUSHIKI KAISHA, Tokyo (JP)

(72) Inventor: Hiroshi Kondo, Yokohama-shi (JP)

(21) Appl. No.: 16/934,621

(22) Filed: Jul. 21, 2020

(30) Foreign Application Priority Data
Jul. 26, 2019 (JP) 2019-137786

(51) Int. Cl. H04N 5/232

(52) U.S. Cl. CPC H04N 5/23212; H04N 5/23296; H04N 5/23299

(57) ABSTRACT

An apparatus includes a capturing unit configured to perform image capturing while changing a focus position to obtain an image, an acquisition unit configured to acquire a focus position for the image capturing, a display unit configured to perform display about a pre-image-captured image acquired by the capturing unit performing pre-image capturing and a focus position of the pre-image-captured image acquired by the acquisition unit, a designation unit configured to designate the focus position to be used for actual image capturing, based on the display, and a combining unit configured to combine a plurality of actual-image-captured images acquired by the capturing unit performing the image capturing with the focus position to be used for the actual image capturing.

### BACKGROUND OF THE INVENTION

### Field of the Invention

The aspect of the embodiment relates to an apparatus that captures a plurality of images with different focus positions.

### Description of the Related Art

In a case where a plurality of objects greatly varying in distance from an image capturing apparatus, such as a digital camera, is imaged, or in a case where an object long in a depth direction is imaged, only a part of the object can be focused due to an insufficient depth of field. To address this, a technique, commonly known as depth composition, is provided in which a plurality of images each having in-focus positions and different angles of view overlapping with one another, only an in-focus region is extracted from each of the images, and the extracted in-focus regions are combined into a single image. Thus, the composite image in which focus is achieved in the entire image capturing region is generated.

According to a technique discussed in Japanese Unexamined Patent Application Publication No. 10-290389, for example, a user cannot select an image region to be used for composition, and thus it is difficult to adjust an out-of-focus region in a composite image.

In view of such an issue, one of techniques to be described below is directed to an image capturing apparatus that enables simple and accurate selection of an image region to be used for composition, when depth composition using a plurality of images varying in in-focus position is performed.

### SUMMARY OF THE INVENTION

According to an aspect of the embodiments, an image capturing apparatus includes an capturing unit configured to perform image capturing while changing a focus position to obtain an image, an acquisition unit configured to acquire a focus position for the image capturing, a display unit configured to perform display about a pre-image-captured image acquired by the capturing unit performing pre-image capturing and a focus position of the pre-image-captured image acquired by the acquisition unit, a designation unit configured to designate the focus position to be used for actual image capturing, based on the display, and a combining unit configured to combine a plurality of actual-image-captured images acquired by the capturing unit performing the image capturing with the focus position to be used for the actual image capturing.

Further features of the disclosure will become apparent from the following description of exemplary embodiments with reference to the attached drawings.

### BRIEF DESCRIPTION OF THE DRAWINGS

FIG. 1 is a block diagram illustrating a configuration example of a digital camera according to an exemplary embodiment of the disclosure.

FIG. 2 is a flowchart illustrating image capturing according to the exemplary embodiment of the disclosure.

FIG. 3 is a flowchart illustrating pre-image capturing according to the exemplary embodiment of the disclosure.

FIG. 4 is a flowchart illustrating setting of parameters for depth composition according to the exemplary embodiment of the disclosure.

FIG. 5 is a diagram illustrating an example of display by a display unit according to the exemplary embodiment of the disclosure.

FIG. 6 is a flowchart illustrating actual image capturing according to the exemplary embodiment of the disclosure.

FIG. 7 is a diagram illustrating an example of performing depth composition in a different apparatus according to the exemplary embodiment of the disclosure.

FIG. 8 is a diagram illustrating an example of displaying peaking according to the exemplary embodiment of the disclosure.

### DESCRIPTION OF THE EMBODIMENTS

An exemplary embodiment of the disclosure will be described in detail below with reference to the accompanying drawings.

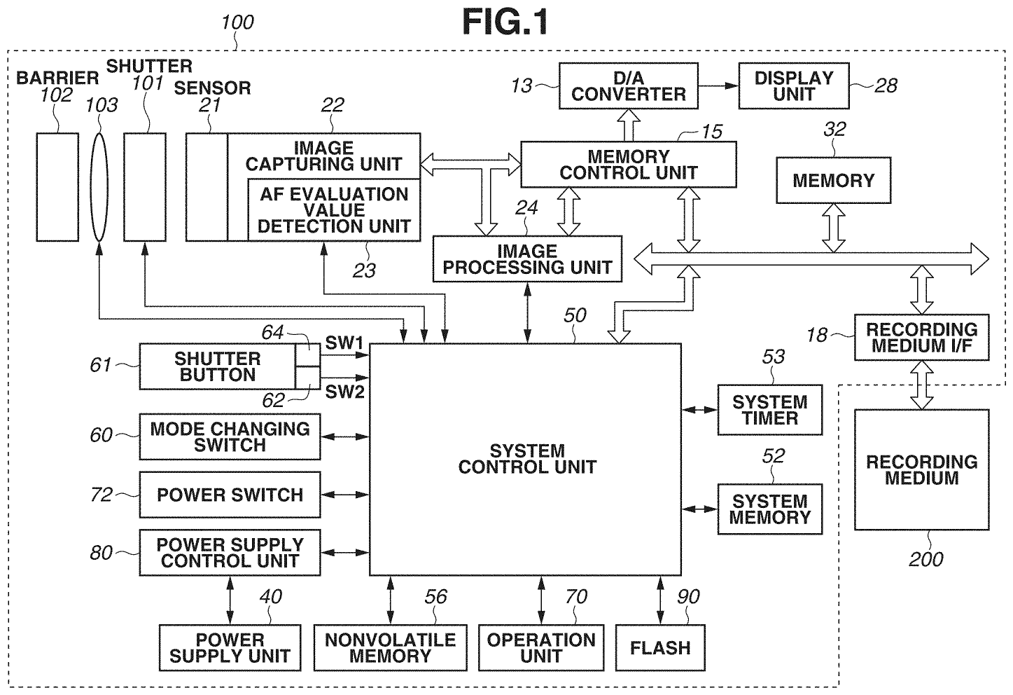

FIG. 1 is a block diagram illustrating a configuration example of a digital camera 100 according to the present exemplary embodiment.

In FIG. 1, a shutter 101 has an aperture function. A barrier 102 covers an image capturing system including an image capturing lens 103 of the digital camera 100, thus protecting the image capturing system including the image capturing lens 103, the shutter 101, and an image capturing unit 22 from dirt and damage. The image capturing lens 103 is a lens group including a zoom lens and a focus lens. A flash 90 can supplement illuminance by emitting light, during image capturing in a low light intensity scene or image capturing in a backlight scene. A sensor 21 is an image sensor including a charge coupled device (CCD) sensor or a complementary metal oxide semiconductor (CMOS) sensor that converts an optical image into an electrical signal.

The image capturing unit 22 includes an analog-to-digital (A/D) conversion processing function, a synchronization signal generator (SSG) circuit that generates a synchronization signal for image capturing driving, a preprocessing circuit that subjects image data to preprocessing, and a luminance integration circuit that subjects image data to luminance integration. The SSG circuit generates horizontal and vertical synchronization signals, in response to clocks for image capturing driving from a timing generator. The preprocessing circuit provides an input image to the luminance integration circuit row by row, and performs processing, such as inter-channel data correction, to be used for captured-image data. The luminance integration circuit mixes luminance components obtained from a red/green/blue (RGB) signal and generates the mixed luminance components. Further, the luminance integration circuit divides the input image into a plurality of regions, and generates the luminance component for each of the regions.

For an automatic focus (AF) evaluation value detection unit 23, any of various methods can be used, and here, a contrast detection method typically adopted in a compact digital camera is used as an example. The AF evaluation value detection unit 23 performs horizontal filter processing for the luminance components of image signals input into an evaluation region (referred to as “AF frame”) set beforehand, selects a maximum value while extracting a predetermined frequency representing contrast, and performs a vertical integration operation, thus calculating an AF evaluation value. The AF evaluation value is calculated while the focus lens of the image capturing lens 103 is being moved in a range from near to infinity, and the focus lens is controlled to stop at a position at which the highest contrast is provided.

The stop position of the focus lens is an in-focus position of an object within the AF frame, and range information can be acquired based on this in-focus position.

The AF evaluation value is output from the image capturing unit 22 to a system control unit 50, and the system control unit 50 performs AF processing based on the AF evaluation value.

An image processing unit 24 includes a circuit that receives a digital output from the image capturing unit 22. The image processing unit 24 further includes a signal processing circuit, a face detection circuit, a reduction circuit, a raster block conversion circuit, and a compression circuit that perform the respective types of processing on the data output from the image capturing unit 22. The signal processing circuit performs color carrier removal, aperture correction, gamma correction, and other processing on the data output from the image capturing unit 22, thus generating a luminance signal. At the same time, the signal processing circuit performs color interpolation, matrix transformation, gamma processing, gain adjustment, and other processing, thus generating a color-difference signal. Thus, YUV-format image data is formed in a memory control unit 15. In response to the output from the signal processing circuit, the reduction circuit performs reduction processing of reducing the pixel data horizontally and vertically, by performing processing such as clipping, thinning, and linear interpolation. The raster block conversion circuit converts raster scan image data that is the data reduced by the reduction circuit, into block scan image data. The memory control unit 15 is used as a buffer memory for implementing a series of these image processes. The compression circuit compresses the YUV image data converted into the block scan data in the buffer memory, based on a compression method.

The image processing unit 24 further performs predetermined arithmetic processing using the image data obtained by image capturing, and the system control unit 50 performs exposure control based on the result of this arithmetic processing. Through-the-lens (TTL) type automatic exposure (AE) processing and electronic flash (EF, automatic flash emission) processing are thus performed. The image processing unit 24 further performs predetermined arithmetic processing using the image data obtained by image capturing, and performs TTL type automatic white balance (AWB) processing based on the result of the arithmetic processing.

The data output from the image capturing unit 22 is written into a memory 32 via the image processing unit 24 and the memory control unit 15, or directly written into the memory 32 via the memory control unit 15. The memory 32 stores image data obtained and subjected to the A/D conversion by the image capturing unit 22, and image data that is generated by the image processing unit 24 and is to be displayed on a display unit 28. The memory 32 has a capacity sufficient for storage of a predetermined number of still images and a moving image with sound for a predetermined length of time. The memory 32 also serves as a memory for image display (a video memory).

A digital to analog (D/A) converter 13 is a playback circuit that converts the image data generated by the image processing unit 24 and stored in the memory control unit 15 into an image for display, and transfers the image for display to a monitor (the display unit 28). The D/A converter 13 separates the YUV-format image data into a luminance component signal Y and a modulation color difference component C. The D/A converter 13 converts the luminance component signal Y into an analog Y signal, and applies a low-pass filter (LPF) to the analog Y signal. The D/A converter 13 converts the modulation color difference component C into an analog C signal, and applies a band-pass filter (BPF) to the analog C signal, thus extracting only the frequency component of the modulation color difference. The D/A converter 13 generates the Y signal and an RGB signal by performing conversion based on the thus generated signal component and a subcarrier frequency, and outputs the generated Y signal and RGB signal to the display unit 28. In this way, the image data from the image sensor is successively processed and the processed image data is displayed, so that a live view (LV) is displayed.

A nonvolatile memory 56 is an electrically erasable recordable memory. Examples of the nonvolatile memory 56 include a flash memory. The nonvolatile memory 56 stores, for example, constants for operating the system control unit 50 and a program. This program is used for executing various flowcharts to be described below in the present exemplary embodiment.

The system control unit 50 controls the entire digital camera 100. The system control unit 50 executes the above-described program recorded in the nonvolatile memory 56 to implement each processes (described below) according to the present exemplary embodiment. For a system memory 52, a random access memory is used. For example, constants and variables for operating the system control unit 50 as well as the program read out from the nonvolatile memory 56 are loaded into the system memory 52. The system control unit 50 also controls display by controlling components such as the memory 32, the D/A converter 13, and the display unit 28.

A system timer 53 is a clocking unit that measures the time to be used for various types of control and the time of a built-in clock.

A mode changing switch 60, a first shutter switch 64, a second shutter switch 62, and an operation unit 70 are operation components for inputting various operation instructions into the system control unit 50.

The mode changing switch 60 is used to change the operating mode of the system control unit 50 to any of modes including a still image recording mode, a moving image recording mode, and a playback mode. The still image recording mode includes, for example, an automatic image capturing mode, an automatic scene determination mode, a manual mode, a depth composition mode, various scene modes for making image capturing settings for the respective image capturing scenes, a program AE mode, and a custom mode. A user can directly change the operating mode to any of these modes included in the still image capturing mode with the mode changing switch 60. Alternatively, the user may first change the operating mode to the still image capturing mode with the mode changing switch 60, and then to any one of the modes included in the still image capturing mode, using another operation member. Similarly, the moving image capturing mode may include a plurality of modes. The first shutter switch 64 is turned on by a shutter button 61 of the digital camera 100 being operated part way, i.e., half pressed (an image capturing preparation instruction), and a first shutter switch signal SW1 is generated. The first shutter switch signal SW1 starts operation for, for example, the AF processing, the AE processing, and the AWB processing.

A second shutter switch 62 is turned on by the operation on the shutter button 61 being completed, i.e., a full pressed (an image capturing instruction), and a second shutter switch signal SW2 is generated. In response to the second shutter switch signal SW2, the system control unit 50 starts operation for a series of image capturing processes from the reading of a signal from the image capturing unit 22 to the writing of image data into a recording medium 200.

Operation members of the operation unit 70 are each appropriately assigned a function for each scene when each of various function icons displayed on the display unit 28 is selected by a user operation, and the operation members act as various function buttons. Examples of the function buttons include an end button, a back button, an image forward button, a jump button, a narrowing button, and an attribute changing button. For example, when a menu button is pressed, a menu screen on which various settings are settable appears on the display unit 28. The user can intuitively make various settings, using the menu screen displayed on the display unit 28, a four-direction (up, down, right, and left) button, and a SET button.

The operation unit 70 includes a controller wheel 73. The controller wheel 73 is an operation member that can be rotated by an operation, and is used, for example, providing an instruction to select an item with a direction of the four-direction button. When the controller wheel 73 is rotated by an operation, an electrical pulse signal is generated based on the amount of the operation, and the system control unit 50 controls each component of the digital camera 100 based on this pulse signal. A rotation angle or the number of rotations of the controller wheel 73 is determined by this pulse signal. The controller wheel 73 may be any type of operation member capable of detecting the rotation of the operation member. For example, the controller wheel 73 may be a dial operation member that generates a pulse signal by rotating in response to an operation by the user. Alternatively, the controller wheel 73 may be an operation member that includes a touch sensor and detects the rotation of a finger of the user on the controller wheel 73 while the controller wheel 73 remains still (a touch wheel).

A power supply control unit 80 includes a battery detecting circuit, a direct current to direct current (DC-DC) converter, and a switch circuit for changing one block to another block to be energized, and detects a remaining battery level. Further, the power supply control unit 80 controls the DC-DC converter based on the result of the detection and an instruction of the system control unit 50, thus supplying each of the components including the recording medium 200 with a voltage for a period of time.

A power supply unit 40 is a primary battery, such as an alkaline cell or lithium battery, or a secondary battery, such a Nickel-Cadmium (NiCd) battery, a nickel metal hydride (NiMH) battery, or a lithium-ion (Li) battery, or an alternating current (AC) adapter. A recording medium interface (I/F) 18 is an interface with the recording medium 200, such as a memory card and a hard disk. The recording medium 200 is a recording medium, such as a memory card, for recording a captured image, and configured of, for example, a semiconductor memory or a magnetic disk. The above-described digital camera 100 is capable of performing image capturing using central one point AF and face AF.

The central one point AF is to perform AF for one point at the center of an image capturing screen. The face AF is to perform AF for a face detected by a face detection function, within the image capturing screen. AF can also be performed for a main object detected within the image capturing screen.

A main object detection function will be described. The system control unit 50 transmits image data to be displayed as a live view or playback to the image processing unit 24. The image processing unit 24 is controlled by the system control unit 50 to group adjacent pixels having close color information based on a feature amount, e.g., color information, in an image, divide the grouped pixels into regions, and store the regions into the memory 32 as object information. Afterward, the image processing unit 24 determines a region having a large area as a main object, among the regions subjected to the grouping.

In this way, the image data to be displayed as a live view or playback is analyzed, and the object information can be can detected by the feature amount of the image data being extracted. In the present exemplary embodiment, the main object is detected based on the color information in the image, but the main object may be detected based on edge information or range information in the image.

### <Operation in Depth Composition Mode>

Next, the depth composition mode in the present exemplary embodiment will be described. Changing to the depth composition mode can be performed by the mode changing switch 60 as described above being changed.

In the depth composition mode in the present exemplary embodiment, a plurality of images is captured while a focus position along an optical axis direction is being changed. Subsequently, only an in-focus region is extracted from each of the images, and the extracted in-focus regions are combined into one image.

To acquire images sufficient for composition, a focus position on the closest side and a focus position on the infinity side to be targets for composition are to be determined (the focus position on the closest side and the focus position on the infinity side are also referred to as “start position” and “end position”, respectively, because images are sequentially captured from the closest side). Further, a focus step to be the amount of movement of the focus lens between one image capturing to the next is also important. An inappropriate focus step may lead to a reduction in the quality of a composite image or an increase in the time to be taken for composition.

In the present exemplary embodiment, the following workflow is implemented. First, in order to determine composition parameters for optimum start position, end position, and focus step, focus-shift moving image capturing is performed as pre-image capturing before actual image capturing. Subsequently, the user determines each of the composition parameters while viewing the moving image obtained by the pre-image capturing, and then the actual mage capturing is performed. Thus, in one embodiment, a tripod for fixing the digital camera 100 is used so that an angle of view remains unchanged between the pre-image capturing and the actual image capturing.

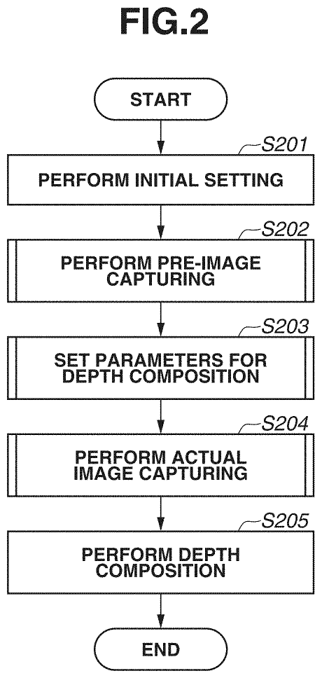

FIG. 2 is a flowchart illustrating image capturing in the present exemplary embodiment.

In step S201, the system control unit 50 performs initial setting (e.g., exposure) for the pre-image capturing. Next, in step S202, the image capturing unit 22 performs the pre-image capturing. In step S203, the display unit 28 plays back a moving image recorded in the pre-image capturing, and the system control unit 50 sets parameters for depth composition based on instructions provided by the user via the operation unit 70 and the display unit 28. In step S204, the image capturing unit 22 performs the actual image capturing. In step S205, the image processing unit 24 performs the depth composition. Operations in step S202 to step S205 will be described in detail below.

### <Pre-Image Capturing>

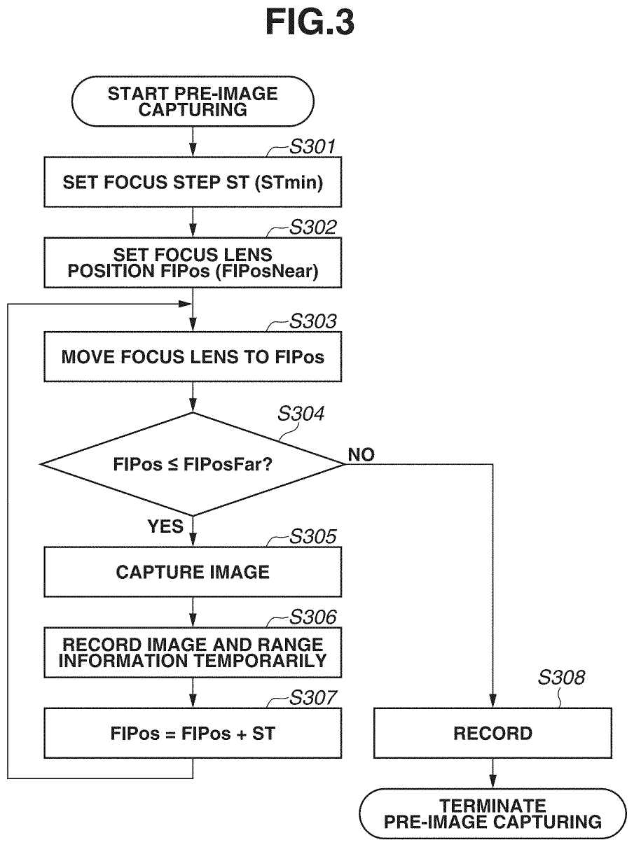

FIG. 3 is a flowchart illustrating the pre-image capturing in the present exemplary embodiment.

In step S301, the system control unit 50 sets a focus step ST. In the processing in FIG. 3, the system control unit 50 sets a minimum focus step STmin to drive the image capturing lens 103.

In step S301, the focus step is set as finely as possible. However, the focus step may be set roughly to some extent due to limitations such as the capacity of the recording medium 200.

In step S302, the system control unit 50 sets a focus lens position FlPos for starting image capturing. In the flow in FIG. 3, a focus lens position FlPosNear for placing the focus position on the closest side is set as the focus lens position FlPos.

In step S303, the system control unit 50 moves the focus lens to the position FlPosNear set in step S302.

In step S304, the system control unit 50 compares the set focus lens position FlPos and a position FlPosfar on the infinity side to determine whether FlPos≤FlPosfar is satisfied. If the position FlPos is closer than or equal to the position FlPosfar (YES in step S304), the processing proceeds to step S305. If the position FlPos is farther than the position FlPosfar (NO in step S304), the processing proceeds to step S308.

In step S305, the image capturing unit 22 captures an image based on the position set in step S303. Subsequently, in step S306, the recording medium 200 temporarily records the image captured by the image capturing unit 22 in step S305 and range information. The range information herein is the position FlPos in step S303.

In step S307, the system control unit 50 increases the value of the position FlPos by the focus step ST. The processing then returns to step S303.

In step S308, the system control unit 50 compresses the images captured in step S305, and records the compressed images into the recording medium 200 as a moving image. The operation in step S308 is performed to reduce the size of data to be recorded, and may be omitted if this operation is unnecessary.

In this way, the pre-image capturing is performed. To obtain a composite image having high perceived resolution, it is important that the focus step is as narrow as possible, and the focus range is as wide as possible, in the pre-image capturing. However, to reduce the data amount, the focus step and the focus range may be appropriately adjusted. Further, a compression rate may be adjusted based on the capacity when a moving image to be recorded in step S308 is created.

### <Setting of Parameters for Depth Composition>

Next, the system control unit 50 sets the parameters for depth composition.

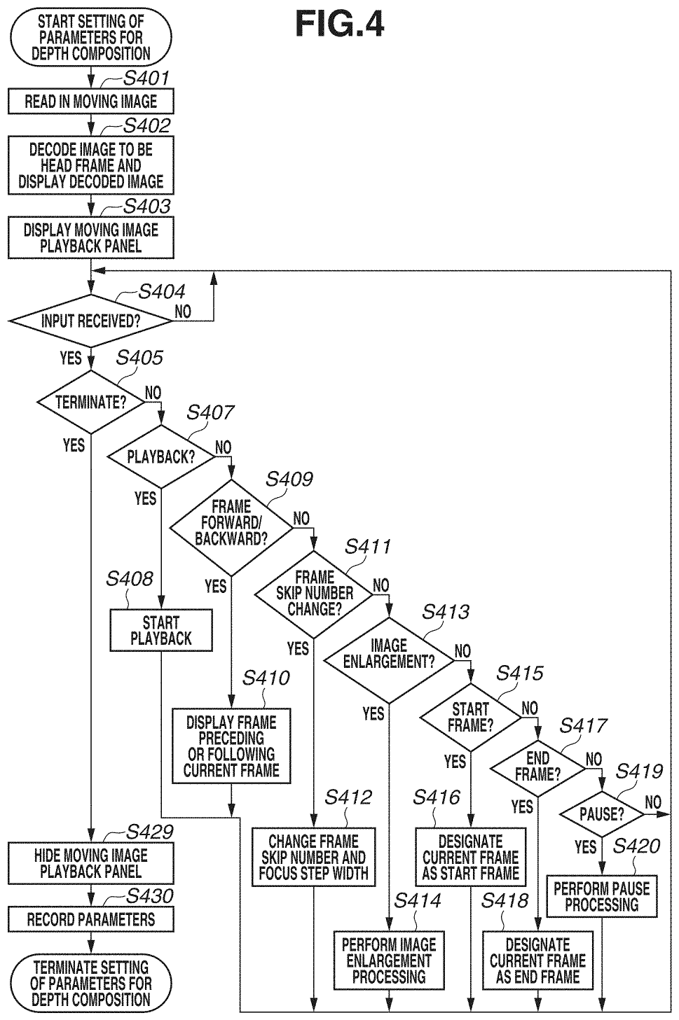

FIG. 4 is a flowchart illustrating a setting of the parameters for depth composition in the present exemplary embodiment.

In step S401, the system control unit 50 reads the moving image acquired in the pre-image capturing in step S202.

In step S402, the display unit 28 decodes the image to be the next head frame and displays the decoded image. In step S403, the display unit 28 displays a moving image playback panel.

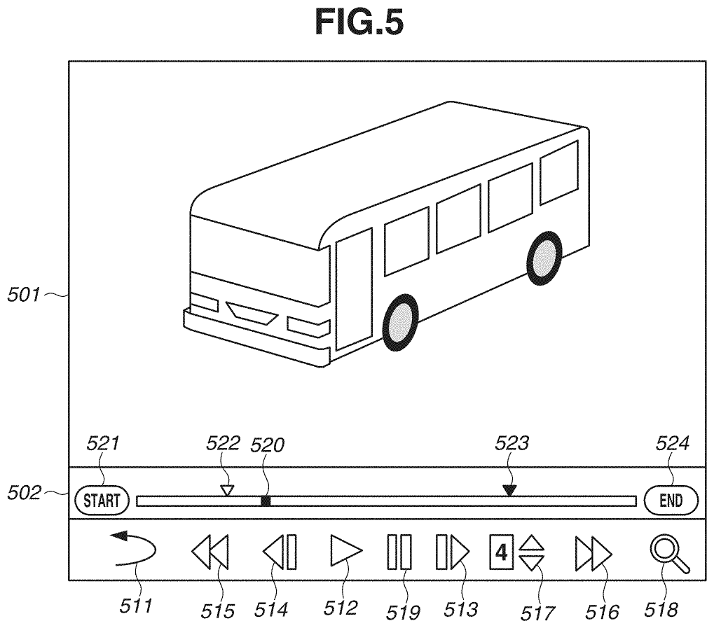

FIG. 5 is a diagram illustrating an example of the display on the display unit 28 in the present exemplary embodiment. In the example illustrated in FIG. 5, a panel for setting the parameters for depth composition after the pre-image capturing is displayed. The panel illustrated in FIG. 5 is substantially similar to a panel to be displayed during normal moving image playback, but some elements such as buttons and icons are added for setting the parameters for depth composition.

In FIG. 5, a frame image 501 (first, the head frame, and afterward, a paused frame) of a moving image being played back is displayed in the background of a moving image playback panel 502. The moving image playback panel 502 includes a dialog box displayed in a lower part of the screen and including a group of buttons and icons. A button 511 is a back button to be used for closing the moving image playback panel 502, and a button 512 is a playback button for providing an instruction to start playback of a moving image. In a case where the button 512 is pressed during playback of a moving image, the moving image is paused at that moment. A button 513 is a frame forward button for providing an instruction to forward a frame, and a button 514 is a frame backward button for providing an instruction to backward a frame. A button 515 is a rewind button used for playback (rewind) in a reverse direction while being pressed, and a button 516 is a fast-forward button used for fast forward while being pressed. A button 517 is a frame skip number changing button for adjusting the number of frames to be skipped during frame forward/frame backward operations, and including two buttons, upper and lower buttons, for increasing and decreasing the number. A button 518 is an enlargement button for receiving an instruction to enlarge an image. A pointer 520 is a distance pointer that indicates a distance to an in-focus position of the focus lens of the current frame. A button 521 is a start frame button for designating a displayed frame as a start frame, and a button 524 is an end frame button for designating a displayed frame as an end frame.

Here, when the button 512 is pressed, playback of the moving image starts from the position of the displayed frame image 501. The playback of the moving image of one scene, including the frame image 501 displayed before start of the playback, continues if a stop instruction is not provided. Touching the display position of each of the buttons included in the moving image playback panel 502, or pressing the SET button in a state where any of the buttons is selected with the four-direction button included in the operation unit 70, may also be referred to as “pressing the button”.

In step S404, the system control unit 50 is in an input waiting state, and determines whether an input is received. If the input is received (YES in step S404), the processing proceeds to step S405. In step S405, the system control unit 50 determines whether the input in step S404 is a termination instruction provided by pressing the back button 511. If the input is the termination instruction (YES in step S405), the processing proceeds to step S429. If the input is not the termination instruction (NO in step S405), the processing proceeds to step S407.

In step S407, the system control unit 50 determines whether the input in step S404 is a playback start instruction provided by pressing the button 512. If the input is the playback start instruction (YES in step S407), the processing proceeds to step S408. In step S408, the system control unit 50 starts playback of the moving image from the current frame.

During the moving image playback, the system control unit 50 displays images sequentially decoded and resized to a display size, on the display unit 28. The system control unit 50 also refers to the range information stored in the pre-image capturing and displays the obtained result as the pointer 520 within the moving image playback panel 502. Inputs can be received during the moving image playback as well, and thus, upon start of the playback, the processing returns to step S404 to enter the input waiting state.

If the input in step S404 is not the playback start instruction (NO in step S407), the processing proceeds to step S409. In step S409, the system control unit 50 determines whether the input in step S404 is either a frame forward instruction or a frame backward instruction. If the input is either the frame forward instruction or frame backward instruction (YES in step S407), the processing proceeds to step S410. In step S410, the system control unit 50 displays the frame preceding or following the currently displayed frame. The processing then returns to step S404 to enter the input waiting state.

If the input is neither the frame forward instruction nor frame backward instruction (NO in step S407), the processing proceeds to step S411. In step S411, the system control unit 50 determines whether the input in step S404 is a frame skip number changing instruction provided by pressing the button 517. The frame skip number indicates the number of frames to be skipped during the frame forward or frame backward. The minimum unit may be one frame. However, a change in the focus step width by one frame is minute, and thus a change in the in-focus position is not always checkable on the screen. Thus, after increasing the frame skip number by pressing the button 517, the user performs the frame forward or frame backward. This enables the user to easily check a change in the in-focus position on the screen.

If the user can eventually check that a change in the in-focus position on the screen is continuous with the displayed frame skip number, the user can perform the actual image capturing with the designated frame skip number, i.e., the focus step width. In other words, if the in-focus position changes continuously and naturally with an increase of the frame skip number, the number of frames for the actual image capturing can be reduced accordingly. This enables a significant reduction in not only the data amount but also the time to be taken for composition.

The frame skip number may be applied to the playback processing in step S408. The time to be taken for the moving image playback during the depth confirmation can be reduced by the above-described configuration.

If the input is the frame skip number changing instruction (YES in step S411), the processing proceeds to step 412. In step 412, the system control unit 50 increases or decreases the frame skip number, based on the pressed button. The operation subsequently returns to step S404 to enter the input waiting state. When changing the frame skip number, the system control unit 50 simultaneously sets the same value as the focus step width. The focus step width having the same value as the value of the frame skip number most recently set can be thus incorporated as the parameter for the actual image capturing. If the input is not the frame skip number changing instruction (NO in step S411), the processing proceeds to step S413. In step S413, the system control unit 50 determines whether the input in step S404 is an image enlargement instruction provided by pressing the button 518. If the input is the image enlargement instruction (YES in step S413), the processing proceeds to step S414. In step S414, the system control unit 50 performs image enlargement processing with a peak point at the time of playback as the center, and displays the result. The operation subsequently returns to step S404 to enter the input waiting state.

If the input is not the image enlargement instruction (NO in step S413), the processing proceeds to step S415. In step S415, the system control unit 50 determines whether the input in step S404 is a start frame instruction provided by pressing the button 521. If the input is the start frame instruction (YES in step S415), the processing proceeds to step S416. In step S416, the system control unit 50 performs processing of designating the current frame as the start frame, and moves a start position mark 522 indicating a start frame position on the moving image playback panel 502 to the designated distance position. The operation subsequently returns to step S404 to enter the input waiting state.

If the input is not the start frame instruction (NO in step S415), the processing proceeds to step S417. In step S417, the system control unit 50 determines whether the input in step S404 is an end frame instruction provided by pressing the button 524. If the input is the end frame instruction (YES in step S417), the processing proceeds to step S418. In step S418, the system control unit 50 performs processing of designating the current frame as the end frame, and moves an end position mark 523 indicating an end frame position on the moving image playback panel 502 to the designated distance position. The operation subsequently returns to step S404 to enter the input waiting state.

If the input is not the end frame instruction (NO in step S417), the processing proceeds to step S419. In step S419, the system control unit 50 determines whether the input in step S404 is a pause instruction provided by pressing the button 519. If the input is the pause instruction (YES in step S419), the processing proceeds to step S420. In S420, the system control unit 50 performs pause processing in the moving image playback. The operation subsequently returns to step S404 to enter the input waiting state.

If the input is not the pause instruction (NO in step S419), the operation returns to step S404 to enter the input waiting state.

In step S429, the system control unit 50 hides the moving image playback panel 502. In step S430, the focus step (ST), the focus lens position (FlPos=FlPosNear) for the start frame, and the focus lens position (FlPosFar) for the end frame designated in the processing are recorded as the parameters, and the processing ends.

As described above, the user can set the parameters while viewing the moving image acquired in the pre-image capturing. Even if the resolution of the moving image is low compared with that of the captured still image, the user can accurately check a difference in range information because the pointer is displayed. In addition, the image can be enlarged by a user operation and the enlarged image can be displayed, and thus the user can check a change in the focus position more clearly. Moreover, the process of setting the parameters for depth composition is performed in the playback state, and thus, power consumption is low compared with that in live view display, which is another beneficial effect.

### <Actual Image Capturing>

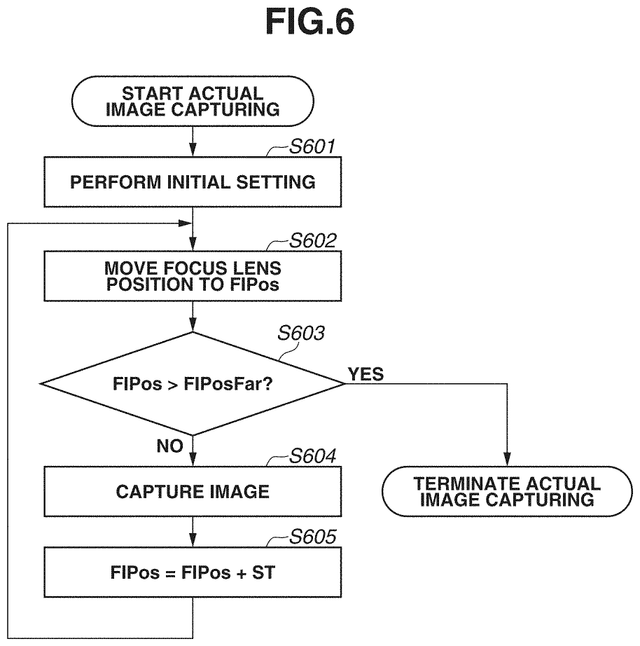

FIG. 6 is a flowchart illustrating the actual image capturing in the present exemplary embodiment.

In step S601, the system control unit 50 performs the live view display by controlling the image capturing unit 22, the image processing unit 24, the display unit 28, and other components, and performs initial setting such as exposure based on information acquired from the image capturing unit 22.

In step S602, the system control unit 50 moves the position of the focus lens to the focus lens position FlPos (=FlPosNear) set in step S430.

In step S603, the system control unit 50 compares the focus lens position FlPos used in step S602 and the focus lens position FlPosFar set in step S430 to determine whether FlPos>FlPosFar is satisfied. If the result of the comparison is FlPos>FlPosFar (YES in step S603), the processing ends. If the result of the comparison is FlPos≤FlPosFar (NO in step S603), the processing proceeds to step S604.

In step S604, the image capturing unit 22 captures an image.

In step S605, the system control unit 50 increases the focus lens position FlPos by the focus step ST. The processing then returns to step S602.

### <Depth Composition>

Finally, in step S205, the image processing unit 24 performs composition for the images captured by the image capturing unit 22 in the actual image capturing.

An example of a depth composition method will be described below. First, the system control unit 50 calculates an amount of positional displacement between two images that are targets for the composition. An example of a calculation method therefor is as follows. First, the system control unit 50 sets a plurality of blocks in one of the images. In one embodiment, the system control unit 50 sets each block to the same size. Next, the system control unit 50 sets a search range in the other image for each set block. Each search range is larger than the corresponding one of the set blocks, and is set at the same position as that of the corresponding one of the blocks. Finally, the system control unit 50 calculates a corresponding point at which the sum of absolute differences (hereinafter, referred to as SAD) in luminance with respect to the initially set block is a minimum, for each of the search ranges of the other image. The system control unit 50 calculates the positional displacement as a vector, based on the center of the initially set block and the above-described corresponding point. The system control unit 50 may use the sum of squared differences (hereinafter, referred to as SSD) or the normalized cross correlation (hereinafter, referred to as NCC), other than the SAD, in calculating the above-described corresponding point.

Next, the system control unit 50 calculates a transformation coefficient based on the amount of the positional displacement. The system control unit 50 uses, for example, a projective transformation coefficient as the transformation coefficient. However, the transformation coefficient is not limited to the projective transformation coefficient, and an affine transformation coefficient or a simplified transformation coefficient employing only horizontal and vertical shifts may be used.

The system control unit 50 can perform transformation through the following equation (1).

$${I}^{′} = ( \begin{matrix}{x}^{′} \\ {y}^{′} \\ 1\end{matrix} ) = A 1 = ( \begin{matrix}a & b & c \\ d & e & f \\ g & h & i\end{matrix} ) ( \begin{matrix}x \\ y \\ 1\end{matrix} ) \qquad ( 1 )$$

where (x′,y′) represents post-transformation coordinates, and (x,y) represents pre-transformation coordinates.

Next, the image processing unit 24 calculates a contrast value for each of the images after alinement. An example of a calculation method for the contrast value is as follows. First, the image processing unit 24 calculates a luminance Y through the following equation (2), based on color signals Sr, Sg, and Sb of each pixel.

Y=0.299Sr+0.587Sg+0.114Sb (2)

Next, the image processing unit 24 calculates a contrast value I using a Sobel filter, based on the following equations (3) to (5), for a matrix L of the luminance Y of 3×3 pixels.

$$\begin{matrix}{l}_{h} = ( \begin{matrix}- 1 & 0 & 1 \\ - 2 & 0 & 2 \\ - 1 & 0 & 1\end{matrix} ) \cdot L & ( 3 ) \\ {l}_{v} = ( \begin{matrix}- 1 & - 2 & - 1 \\ 0 & 0 & 0 \\ 1 & 2 & 1\end{matrix} ) \cdot L & ( 4 ) \\ l = \sqrt{{l}_{h}^{2} + {l}_{v}^{2}} & ( 5 )\end{matrix}$$

The above-described calculation method for the contrast value is merely an example. Alternatively, an edge-detection filter, such as a Laplacian filter, or a band-pass filter that passes a predetermined band of frequencies may also be used, for example.

The image processing unit 24 then generates a composite map. A method for generating the composite map is as follows. The image processing unit 24 compares the contrast values of the pixels at the same position in the respective images, sets the composition ratio of the pixel having the highest contrast value to 100% and sets the composition ratio of the other pixel at the same position to 0%. The image processing unit 24 sets such a composition ratio for all positions in the images.

Finally, the image processing unit 24 replaces the pixels based on the composite map, and thus generating a composite image. In the case of using the composition ratio thus calculated, if the composition ratio changes from 0% to 100% (or from 100% to 0%) between the adjacent pixels, the image at the composition border can be noticeably unnatural. Thus, a filter having a predetermined number of pixels (the number of taps) is applied to the composite map to prevent the composition ratio from changing sharply between the adjacent pixels.

The digital camera 100 is described to perform all the operations in the processing, but this is not limitative. For example, a different image processing apparatus may perform the depth composition in step S205.

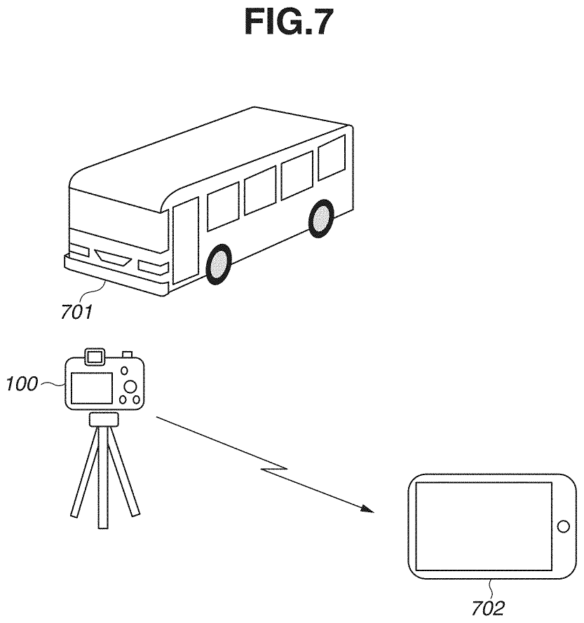

FIG. 7 is a diagram illustrating an example of performing the depth composition in a different apparatus in the present exemplary embodiment. FIG. 7 illustrates the digital camera 100, an information processing apparatus 702 for designating the parameters for depth composition, and an image capturing target 701 (a model of a bus). The configuration as illustrated in FIG. 7 enables the user to set the parameters without touching the digital camera 100. If the user can remotely control the digital camera 100, the user can perform all operations using the information processing apparatus 702 without touching the digital camera 100.

According to the present exemplary embodiment, the display unit 28 can have a peaking function of displaying peaking. The peaking function is the function of displaying an image overlaid with a hatch pattern or a colored edge based on information such as contrast of the image in such a manner that a portion in focus is highlighted, and the image processing unit 24 performs processing for the peaking function.

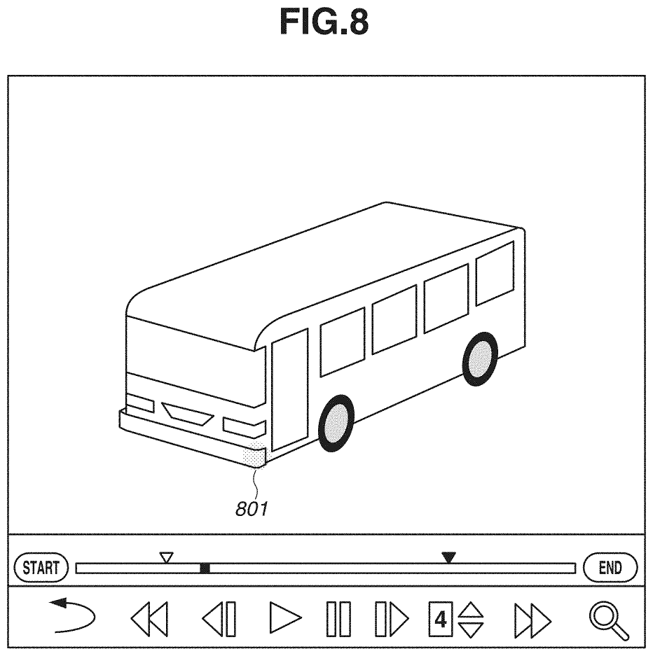

FIG. 8 is a diagram illustrating an example of displaying peaking according to the present exemplary embodiment. FIG. 8 illustrates a state where information representing peaking and the moving image captured in the pre-image capturing are displayed by the display unit 28 after the pre-image capturing. A region 801 indicates an area where peaking is displayed. Upon starting the playback of the moving image, the system control unit 50 changes the display area for peaking, based on the in-focus position.

The information about peaking may be generated from the range information acquired to in step S306, and the generated information may be added to the captured image.

Storing the information about peaking as data separately from the captured image is also beneficial. In a case where the user wants to change the color or intensity of peaking depending on the situation, or a case where the user wants to display not only the peaking information for the current frame but also the peaking information for the next frame, the information can be freely added. This makes it easy to designate the parameters for depth composition.

As described above, the resolution of the moving image to be recorded during the pre-image capturing is described to be lower than that of the still image. However, the driving mode of the sensor 21 may be configured to read out all the pixels without performing thinning and addition, in order to extract the information about peaking with a higher accuracy.

The above-described configuration enables peaking to be displayed more accurately during the moving image playback after the pre-image capturing.

According to the present exemplary embodiment, the image acquired in the pre-image capturing is displayed for the user and the user sets the parameters while viewing the displayed image, so that the region to be used for the composition can be selected simply and accurately.

### Other Embodiments

Exemplary embodiments are described above based on an embodiment with the digital camera, but the disclosure is not limited to the digital camera. For example, a portable device with a built-in image sensor may be used, and a network camera capable of capturing an image may also be used.

The disclosure can also be implemented by supplying a program that implements one or more functions of the above-described exemplary embodiment to a system or apparatus via a network or storage medium, and causing one or more processors in a computer of the system or apparatus to read out the program and run the read-out program. The disclosure can also be implemented by a circuit (e.g., an application-specific integrated circuit (ASIC)) for implementing the one or more functions.

According to the present exemplary, it is possible to provide the image capturing apparatus that enables easy selection of the region to be used for the composition in performing the depth composition.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-137786, filed Jul. 26, 2019, which is hereby incorporated by reference herein in its entirety.

What is claimed is:

1. An apparatus comprising:
a capturing unit configured to perform image capturing while changing a focus position to obtain an image;
an acquisition unit configured to acquire a focus position for the image capturing;
a display unit configured to perform display about a pre-image-captured image acquired by the capturing unit performing pre-image capturing and a focus position of the pre-image-captured image acquired by the acquisition unit;
a designation unit configured to designate the focus position to be used for actual image capturing, based on the display; and
a combining unit configured to combine a plurality of actual-image-captured images acquired by the capturing unit performing the image capturing with the focus position to be used for the actual image capturing.

2. The apparatus according to claim 1, wherein the plurality of actual-image-captured images overlap with each other in at least a part of an angle of view.

3. The apparatus according to claim 1, wherein a setting about an angle of view and an aperture for image capturing is the same in the actual image capturing and the pre-image capturing, when the capturing unit performs the actual image capturing and the pre-image capturing with the same focus position.

4. The apparatus according to claim 1, wherein the designation unit designates a start focus position, an end focus position, and a focus step for the actual image capturing.

5. The apparatus according to claim 4, wherein the designation unit designates the focus step based on a number of skips for display of the image acquired in the pre-image capturing, the display being performed by the display unit.

6. The apparatus according to claim 1, wherein the focus position is a focus position along an optical axis direction.

7. The apparatus according to claim 1, wherein the focus position for the pre-image capturing includes the focus position for the actual image capturing.

8. The apparatus according to claim 1, wherein the display unit displays information about peaking based on the acquired focus position in the pre-image capturing.

9. The apparatus according to claim 8, wherein the display unit displays the acquired image acquired in the pre-image capturing, and the information about peaking corresponding to the focus position of the image.

10. The apparatus according to claim 9, wherein the information about peaking is obtained from a contrast value of the image.

11. The apparatus according to claim 1, wherein the display unit plays back the image acquired in the pre-image capturing, as a moving image.

12. A method comprising:
performing image capturing while changing a focus position to obtain an image;
acquiring a focus position for the image capturing;
performing display about a pre-image-captured image acquired in the image capturing through pre-image capturing and an acquired focus position of the pre-image-captured image;
designating the focus position to be used for actual image capturing, based on the display; and
combining a plurality of actual-image-captured images acquired in the image capturing with the focus position to be used for the actual image capturing.

13. The method according to claim 12, wherein the plurality of actual-image-captured images overlap with each other in at least a part of an angle of view.

14. The method according to claim 12, wherein a setting about an angle of view and an aperture for image capturing is the same in the actual image capturing and the pre-image capturing, when the capturing unit performs the actual image capturing and the pre-image capturing with the same focus position.

15. The method according to claim 12, wherein the designating designates a start focus position, an end focus position, and a focus step for the actual image capturing.

16. A computer-readable storage medium storing a program that causes a computer to operate as an image capturing apparatus that executes:
performing image capturing while changing a focus position to obtain an image;
acquiring a focus position for the image capturing;
performing display about a pre-image-captured image acquired in the image capturing through pre-image capturing and an acquired focus position of the pre-image-captured image;
designating the focus position to be used for actual image capturing, based on the display; and
combining a plurality of actual-image-captured images acquired in the image capturing with the focus position to be used for the actual image capturing.

17. The computer-readable storage medium according to claim 16, wherein the plurality of actual-image-captured images overlap with each other in at least a part of an angle of view.

18. The computer-readable storage medium according to claim 16, wherein a setting about an angle of view and an aperture for image capturing is the same in the actual image capturing and the pre-image capturing, when the capturing unit performs the actual image capturing and the pre-image capturing with the same focus position.

19. The computer-readable storage medium according to claim 16, wherein the designating designates a start focus position, an end focus position, and a focus step for the actual image capturing.
